(19) United States
(12) Patent Application Publication
(10) Pub. No.: US 2016/0275932 A1
(43) Pub. Date: Sep. 22, 2016

(54) Sound Masking Apparatus and Sound Masking Method

(71) Applicant: Yamaha Corporation, Hamamatsu-shi (JP)

(72) Inventors: Masato HATA, Hamamatsu-shi (JP); Takashi YAMAKAWA, Iwata-shi (JP)

(21) Appl. No.: 15/074,657

(22) Filed: Mar. 18, 2016

(30) Foreign Application Priority Data
Mar. 20, 2015 (JP) 2015-058737

(51) Int. Cl. G10K 11/175

(52) U.S. Cl. CPC G10K 11/175

(57) ABSTRACT

A sound masking apparatus includes an information acquirer which acquires a mixing ratio between a disturbing sound and a non-disturbing sound which are included in a masker sound, and a volume controller which controls a volume of the disturbing sound and a volume of the non-disturbing sound so as to be the mixing ratio, while a volume of the masker sound is a constant value.

### CROSS REFERENCE TO RELATED APPLICATION

This application is based on Japanese Patent Application (No. 2015-058737) filed on Mar. 20, 2015, the contents of which are incorporated herein by reference. Also, all the references cited herein are incorporated as a whole.

### BACKGROUND

1. Field of the Invention

The present disclosure relates to a technique for preventing overhearing of a sound by utilizing a masking effect.

2. Description of the Related Art

Various sound masking apparatuses are known in the art that emit a masker sound to make it difficult for a third party to hear a sound (for example, a talking) made by a particular person or a conversation between particular persons within an acoustic space. Such a sound masking apparatus emits a masker sound generated by mixing a disturbing sound with an environmental sound for reducing discomfort that can be caused by the disturbing sound. The disturbing sound is meaningless or unintelligible and is generated by scrambling a human voice. Thus, the disturbing sound enhances a masking effect, and the environmental sound reduces discomfort caused by the disturbing sound and felt by a third party.

For example, a masking sound generating apparatus disclosed in JP-A-2008-233670 scrambles a sound signal of a human voice to generate a scrambled signal (i.e., a sound signal of a disturbing sound), mixes the scrambled signal with a noise signal generated from random noise, such as white noise, and emits the resulting sound as a masker sound. The masking sound generating apparatus includes a table in which relative ratios between the levels of the scrambled signal and noise signal are associated with master volume values (or volumes) of the resulting masker sound. For example, when the relative ratio (or mixing ratio) between the levels of the scrambled signal and noise signal is 70:30, the master volume is set at 26 dB. When the mixing ratio is 90:10, the master volume is set at 22 dB. The master volume for the scrambled signal that makes up a large proportion of the masker sound is set at a lower level than the master volume for the scrambled signal that makes up a small proportion of the masker sound. This is because when the scrambled signal makes up a large proportion of the masker sound, discomfort felt by a third party increases, and thus the master volume has to be set at a low level to reduce the effect of the scrambled signal. The values listed in the table are displayed on an input means. Through the input means, a user adjusts the mixing ratio or the master volume. Accordingly, the masking sound generating apparatus generates, with reference to the table, a masker sound in accordance with the user-set mixing ratio between the scrambled and noise signals and master volume value associated with the mixing ratio, and emits the masker sound.

In general, a masking effect is enhanced as the volume of a masker sound is increased. A masker sound, however, will be noisier for a user as the volume of the masker sound is increased. Thus, in generating a desired masker sound using a sound masking apparatus, a user usually initially sets the volume of a masker sound at an appropriate level that prevents the masker sound from being noisy for the user. A masking effect, however, is determined on the basis of a mixing ratio as well as the volume of a masker sound as already mentioned. Even if the volume of a masker sound is set to an appropriate volume, a mixing ratio also has to be appropriate in order to achieve a desired masking effect. Accordingly, a user needs to adjust a mixing ratio to an appropriate value after having set the volume of a masker sound at an appropriate level.

In using the masking sound generating apparatus disclosed in JP-A-2008-233670, the user may set the master volume at an appropriate value, and then may change the mixing ratio. In that case, the value of the master volume initially set by the user is also changed. This is because each master volume value of the masker sound is associated with the corresponding mixing ratio in the table, and thus a change in the mixing ratio changes the volume of the masker sound to the master volume value associated with the resulting mixing ratio. For example, when the user sets the master volume value at 22 dB, the mixing ratio is set at 90:10. Suppose that the user changes this mixing ratio to 70:30 because the masking effect is too small for the user, although the master volume value is appropriate. In that case, the master volume value is automatically changed to 26 dB, which means that the initially set volume is increased by 4 dB. Thus, in using the masking sound generating apparatus disclosed in JP-A-2008-233670, a change in the mixing ratio changes the master volume value, and a change in the master volume value changes the mixing ratio. This compels the user to adjust the master volume value and the mixing ratio over and over again in order to provide a desired masker sound. Consequently, the user is forced to adjust the master volume value and the mixing ratio with difficulty in providing a desired masker sound.

### SUMMARY

The present disclosure has been made in view of the above-described circumstances, and its object is to provide a technique for facilitating adjustment of a mixing ratio between a disturbing sound and an environmental sound and adjustment of the volume of a masker sound.

There is provided a sound masking apparatus according to one aspect of the present disclosure comprising:

an information acquirer configured to acquire a mixing ratio between a disturbing sound and a non-disturbing sound which are included in a masker sound; and

a volume controller configured to control a volume of the disturbing sound and a volume of the non-disturbing sound so as to be the mixing ratio, while a volume of the masker sound is a constant value.

### BRIEF DESCRIPTION OF THE DRAWINGS

FIG. 1 is a block diagram illustrating a configuration of a sound masking apparatus 1 according to an embodiment of the present disclosure.

FIG. 2 is a graph illustrating relationships of a mixing ratio P with a signal level Ls of disturbing sound data, a signal level Le of environmental sound data, and a masker sound level Lm in the present embodiment.

FIG. 3 is a graph illustrating results of a word intelligibility test conducted on a subject in the present embodiment, with forest sounds used as environmental sounds.

FIG. 4 is a graph illustrating results of a word intelligibility test conducted on nine subjects in the present embodiment, with forest sounds used as environmental sounds.

FIG. 5 is a graph illustrating results of a word intelligibility test conducted on nine subjects in the present embodiment, with crowd sounds used as environmental sounds.

FIG. 6 illustrates an example of a table 240 according to a variation of the present disclosure.

### DETAILED DESCRIPTION OF THE EXEMPLARY EMBODIMENTS

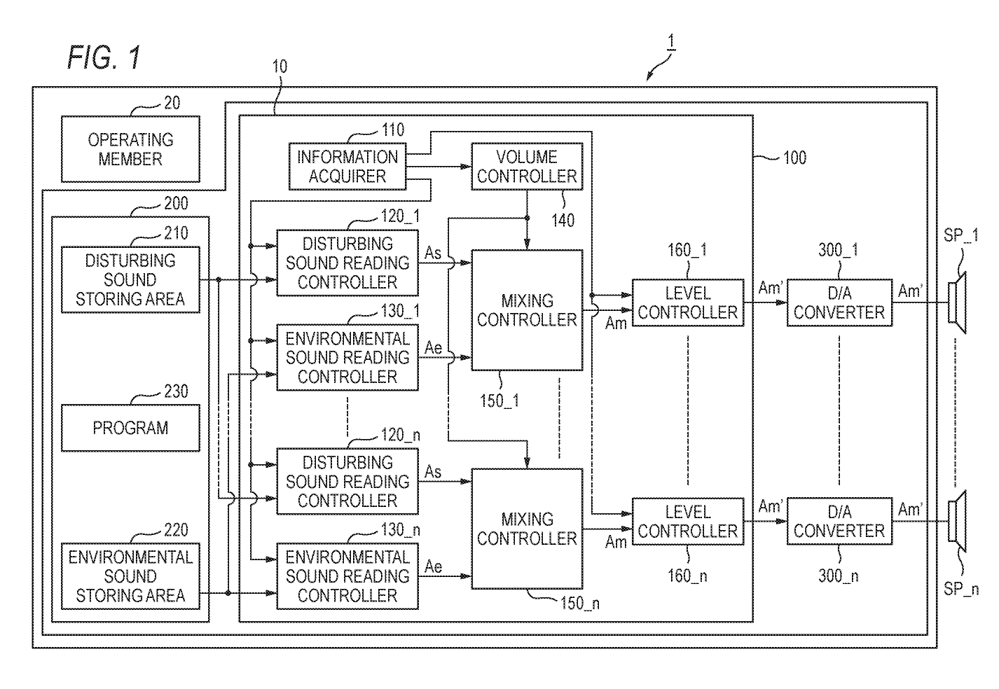

FIG. 1 is a block diagram illustrating a configuration of a sound masking apparatus 1 according to an embodiment of the present disclosure. As illustrated in FIG. 1, the sound masking apparatus 1 includes a masker sound generator 10, an operating member 20, and speakers SP_1 to SP_n (n=2 to N). Although the number of speakers may be any number and N may be any number greater than 2, two speakers, i.e., the speakers SP_1 and SP_n, are illustrated by way of example in FIG. 1. The masker sound generator 10 generates, utilizing a masking effect, masker sound data of a masker sound for preventing overhearing of a sound, and outputs the masker sound data to the speakers SP_1 to SP_n. Specifically, the masker sound generator 10 according to the present embodiment mixes a disturbing sound that is a scrambled human voice with a non-disturbing sound, thus generating a masker sound to be emitted from each of the speakers SP_1 to SP_n. In the present embodiment, an environmental sound is used as the non-disturbing sound. Alternatively, white noise or music may be used as the non-disturbing sound. The operating member 20 includes operating element(s), such as a push button, a volume knob, and/or a touch panel, provided on a casing of the sound masking apparatus 1.

The masker sound generator 10 includes a CPU 100, a storage 200, and D/A converters 300_1 to 300_n (n=2 to N). Although the number of D/A converters may be any number and N may be any number greater than 2, two D/A converters, i.e., the D/A converters 300_1 and 300_n, are illustrated by way of example in FIG. 1. The storage 200 is a read-only memory (ROM), for example. The storage 200 includes a disturbing sound storing area 210 and an environmental sound storing area 220. The storage 200 stores a program 230. The CPU 100 executes the program 230 to control operations of the components of the masker sound generator 10.

The disturbing sound storing area 210 stores disturbing sound data. The disturbing sound data is a sample data sequence of waveforms of disturbing sounds. As used herein, the term “disturbing sound data” refers to waveform data of a sound obtained by making a human voice meaningless or unintelligible, for example. Specifically, human voices are collected to generate waveform data, the waveform data is divided into a plurality of frames each having a predetermined time length, and the frames are rearranged in a sequence different from that in which frames of original sounds are arranged, thus generating new waveform data as disturbing sound data.

The environmental sound storing area 220 stores environmental sound data. The environmental sound data is sample data of waveforms of environmental sounds, such as forest sounds (e.g., bird song, and tree rustling sounds), wave sounds, crowd sounds (e.g., everyday sounds heard in the city), and air-conditioning sounds.

As illustrated in FIG. 1, functions implemented by execution of the program in the storage 200 by the CPU 100 include an information acquirer 110, disturbing sound reading controllers 120_1 to 120_n (n=2 to N); environmental sound reading controllers 130_1 to 130_n (n=2 to N); a volume controller 140, mixing controllers 150_1 to 150_n (n=2 to N), and level controllers 160_1 to 160_n (n=2 to N). Although the number of disturbing sound reading controllers may be any number and N may be any number greater than 2, two disturbing sound reading controllers, i.e., the disturbing sound reading controllers 120_1 and 120_n, are illustrated by way of example in FIG. 1. Although the number of environmental sound reading controllers may be any number and N may be any number greater than 2, two environmental sound reading controllers, i.e., the environmental sound reading controllers 130_1 and 130_n, are illustrated by way of example in FIG. 1. Although the number of mixing controllers may be any number and N may be any number greater than 2, two mixing controllers, i.e., the mixing controllers 150_1 and 150_n, are illustrated by way of example in FIG. 1. Although the number of level controllers may be any number and N may be any number greater than 2, two level controllers, i.e., the level controllers 160_1 and 160_n, are illustrated by way of example in FIG. 1.

The information acquirer 110 acquires a mixing ratio between disturbing and non-disturbing sounds to be included in a masker sound. The information acquirer 110 also acquires various pieces of information input by operation of the operating member 20. More specifically, the information acquirer 110 operates as follows. A user selects an environmental sound type by operating the operating member 20. In response to this, the information acquirer 110 provides an environmental sound data reading instruction to each of the environmental sound reading controllers 130_1 to 130_n. The environmental sound data reading instruction includes information indicative of the environmental sound type selected by the user. In response to the selecting operation, the information acquirer 110 also provides a disturbing sound data reading instruction to each of the disturbing sound reading controllers 120_1 to 120_n. The user sets a mixing ratio between the disturbing and environmental sounds by operating the operating member 20. In response to this, the information acquirer 110 provides a calculation instruction for the volumes of the disturbing and environmental sounds to the volume controller 140. The calculation instruction includes the mixing ratio. The user sets a masker sound volume (or sound pressure level) Ln by operating the operating member 20. In response to this, the information acquirer 110 provides a level control instruction to each of the level controllers 160_1 to 160_n. The level control instruction is provided to execute a level control process (which will be described below). The level control instruction includes volume information indicative of the masker sound volume Ln.

Upon receiving, from the information acquirer 110, the reading instruction including information indicative of a disturbing sound type, the disturbing sound reading controllers 120_1 to 120_n each read disturbing sound data As corresponding to the type from the disturbing sound storing area 210 of the storage 200, and provide the disturbing sound data As to the associated one of the mixing controllers 150_1 to 150_n. Upon receiving, from the information acquirer 110, the reading instruction including information indicative of the environmental sound type, the environmental sound reading controllers 130_1 to 130_n each read environmental sound data Ae corresponding to the type from the environmental sound storing area 220 of the storage 200, and provide the environmental sound data Ae to the associated one of the mixing controllers 150_1 to 150_n.

The volume controller 140 decides the volume of a disturbing sound and the volume of a non-disturbing sound (or environmental sound) so that the ratio between the volumes of the disturbing sound and environmental sound in a masker sound is equal to the mixing ratio acquired by the information acquirer 110, while the volume of the masker sound is a constant value. As used herein, the term “volume of a disturbing sound” refers to the signal level of the disturbing sound data As on which the disturbing sound is based, and the term “volume of a non-disturbing sound” refers to the signal level of the environmental sound data Ae on which the environmental sound is based. To carry out the volume control, the volume controller 140 decides a disturbing sound level Ls, i.e., the signal level of the disturbing sound data As, and an environmental sound level Le, i.e., the signal level of the environmental sound data Ae, using calculation methods described below.

First, a masker sound level Lm is the signal level of masker sound data Am obtained as a result of mixing, and is determined using the following equation:

10 log(10^{Ls/10}+10^{Le/10})=Lm (1)

where Ls represents a dB value that is a logarithmic voltage value indicated by the disturbing sound data As, and Le represents a dB value that is a logarithmic voltage value indicated by the environmental sound data Ae.

A modification to Equation (1) yields the following equation:

10^{Ls/10}+10^{Le/10}=10^{Lm/10} (2)

In Equation (2), the first term on the left-hand side, i.e., represents the volume of the disturbing sound to be emitted in accordance with the disturbing sound data As, the second term on the left-hand side, i.e., 10^{Le/10}, represents the volume of the environmental sound to be emitted in accordance with the environmental sound data Ae, and the right-hand side, 10^{Lm/10}, represents the volume of the masker sound to be emitted in accordance with the masker sound data Am. Although the present embodiment has been described on the assumption that the mixing ratio is the ratio between the disturbing sound and environmental sound mixed in the masker sound for the sake of convenience, the term “mixing ratio” hereinafter refers to the ratio of the disturbing sound to the whole masker sound, and is represented as a mixing ratio P (0≦P≦1). In other words, the ratio of the non-disturbing sound to the whole masker sound is represented as 1−P. The mixing ratio P (P=0 to 1) is given by the following equation: P=10^{Ls/10}/(10^{Ls/10}+10^{Le/10}). Thus, the volume of the disturbing sound data As (i.e., 10^{Ls/10}) in the first term on the left-hand side of Equation (2) is given by the following equation:

10^{Ls/10}=P10^{Lm/10} (3)

From Equation (3), the disturbing sound level Ls and the environmental sound level Le are calculated using the following equations:

Ls=Lm+10 log P (4)

Le=Lm+10 log(1−P) (5)

Thus, on the basis of the mixing ratio P and the masker sound level Lm, the volume controller 140 calculates the disturbing sound level Ls using Equation (4) and calculates the environmental sound level Le using Equation (5).

Because the signal level Ls of the disturbing sound data As is determined by Equation (4) and the signal level Le of the environmental sound data Ae is determined by Equation (5), the ratio P of the volume of the disturbing sound (i.e., 10^{Ls/10}), which is to be emitted in accordance with the disturbing sound data As, to the whole masker sound is adjusted to a desired value, while the masker sound volume (which is given by the following equation:

10^{Lm/10}=10^{Ls/10}+10^{Le/10}) is always maintained constant.

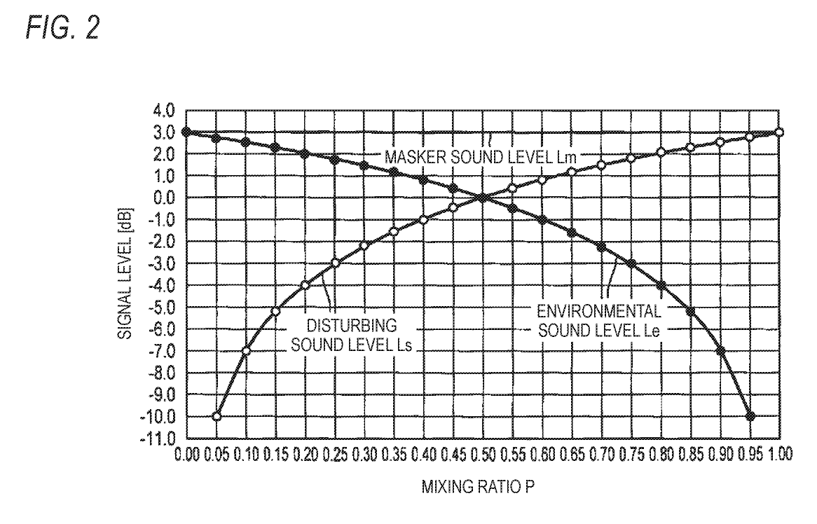

FIG. 2 is a graph illustrating relationships of the mixing ratio P with the disturbing sound level Ls, the environmental sound level Le, and the masker sound level Lm. In FIG. 2, the horizontal axis represents the mixing ratio P, and the vertical axis represents the disturbing sound level Ls, the environmental sound level Le, and the masker sound level Lm. The disturbing sound level Ls and the environmental sound level Le in FIG. 2 are respectively obtained using Equations (4) and (5), where Lm=3 dB. As illustrated in FIG. 2, as the mixing ratio P increases, the disturbing sound level Ls increases, while the environmental sound level Le decreases; nevertheless, the masker sound level Lm obtained as a result of mixing is always kept constant at 3 dB, which means that the masker sound level Lm is unchanged.

The mixing controllers 150_1 to 150_n each receive results of calculation of the disturbing sound level Ls and the environmental sound level Le from the volume controller 140. The mixing controllers 150_1 to 150_n each adjust the levels of the disturbing sound data As and the environmental sound data Ae so that the signal levels of the disturbing sound data As and the environmental sound data Ae respectively agree with the disturbing sound data signal level Ls and the environmental sound data signal level Le. After having performed the level adjustment, the mixing controllers 150_1 to 150_n each mix the resulting disturbing sound data As and environmental sound data Ae. The mixing controllers 150_1 to 150_n each provide, to the associated one of the level controllers 160_1 to 160_n, the masker sound data Am having the masker sound level Lm obtained as a result of the mixing.

The level controllers 160_1 to 160_n each adjust the masker sound to the volume indicated by volume information acquired by the information acquirer 110. Upon receiving a level control instruction from the information acquirer 110, the level controllers 160_1 to 160_n each calculate a difference between the masker sound level Lm and the volume Ln specified by the level control instruction (or set by the user). This difference is represented as Ln−Lm. The level controllers 160_1 to 160_n each amplify the masker sound data Am by a gain corresponding to the difference (Ln−Lm), and output the amplified masker sound data Am′ having the level Ln to the associated one of the D/A converters 300_1 to 300_n.

The D/A converters 300_1 to 300_n each convert the masker sound data Am′ from a digital masker sound signal into an analog masker sound signal, and output the analog masker sound signal to the associated one of the speakers SP_1 to SP_n. The speakers SP_1 to SP_n each receive the masker sound signal output from the associated one of the D/A converters 300_1 to 300_n, and emit the masker sound signal in the form of a masker sound.

The sound masking apparatus 1 according to the present embodiment has been described in detail above.

In the present embodiment, the user operates the operating member 20 to select the disturbing sound type and environmental sound type, and sets the masker sound volume at an appropriate level that prevents the masker sound from being noisy. The user also operates the operating member 20 to adjust the mixing ratio P between the disturbing sound and environmental sound in accordance with a desired masking effect.

Suppose that the user changes the mixing ratio P from Px to Px′ (>Px) due to a situation where a speaking voice in the vicinity of the user is loud, for example. In that case, the information acquirer 110 provides, to the volume controller 140, a calculation instruction including the new mixing ratio Px′ set by the user. Upon receiving the instruction from the information acquirer 110, the volume controller 140 calculates, on the basis of the value of Px′, the disturbing sound level Ls and the environmental sound level Le using Equation (4) and Equation (5), respectively, and provides the calculation results to the mixing controllers 150_1 to 150_n.

Thus, the ratio of the volume of the disturbing sound data As to the volume of the masker sound data Am to be output from each of the mixing controllers 150_1 to 150_n increases from Px to Px′ (<Px), but the volume of the masker sound data Am is unchanged. Consequently, the masking effect is enhanced without any increase in masker sound-induced discomfort. Although the example where the mixing ratio P is increased has been described, the mixing ratio P may be increased or reduced to achieve a desired masking effect.

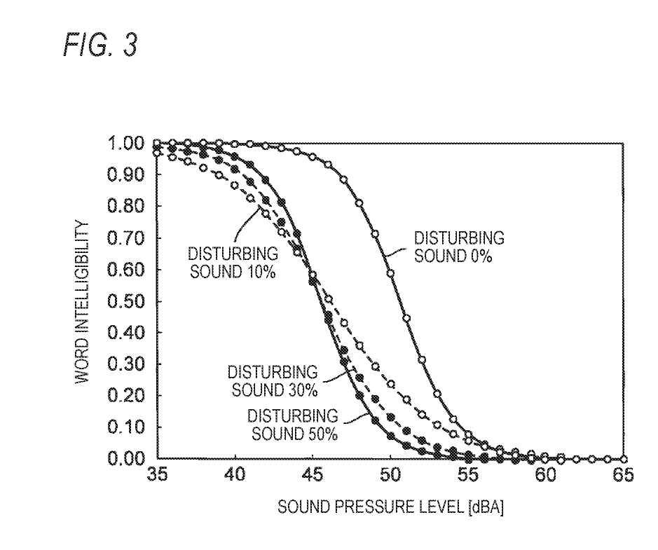

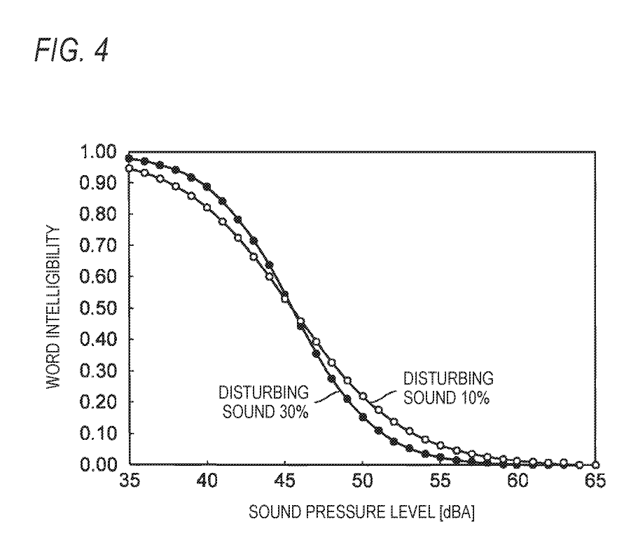

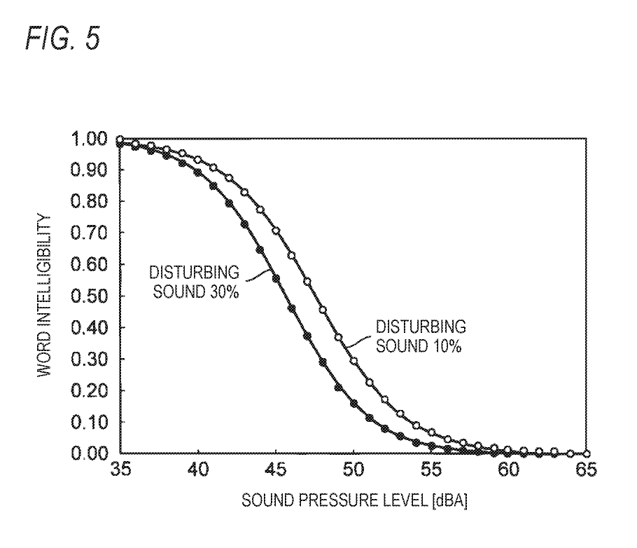

FIG. 3 is a graph illustrating results of a word intelligibility test conducted on a subject using the sound masking apparatus 1. In FIG. 3, the horizontal axis represents a masker sound pressure level, and the vertical axis represents a word intelligibility. The masker sound pressure level in FIG. 3 is an A-weighted sound pressure level. The same goes for FIGS. 4 and 5. As used herein, the term “word intelligibility” refers to a value indicative of how accurately words are conveyed to a listener, and is defined as the ratio of the number of words completely intelligible to a listener to the number of words spoken by a person. For example, when one of ten words is intelligible to a listener, the word intelligibility is 0.10. When all of ten words are intelligible to a listener, the word intelligibility is 1.00. Because words used in the test are intelligible to the subject with high probability when the word intelligibility is 0.50 or higher, actually meaningful data is obtained when the word intelligibility is 0.50 or lower. In this test, the inventors used forest sounds as environmental sounds, and determined relationships between the word intelligibility and the masker sound pressure level, with the mixing ratio P (or disturbing sound ratio) set to 0%, 10%, 30%, and 50%.

As illustrated in FIG. 3, the masker sound pressure level necessary for a word intelligibility of 0.10 is about 49.5 dBA when the mixing ratio P is 50%, about 50.5 dBA when the mixing ratio P is 30%, about 53.0 dBA when the mixing ratio P is 10%, and about 54.5 dBA when the mixing ratio P is 0%. Accordingly, to obtain a word intelligibility of 0.10, the user has to set the masker sound pressure level in the range of about 49.5 dBA to about 54.5 dBA, and adjust the mixing ratio P, with the masker sound pressure level set within this range. For example, when the user sets the masker sound pressure level at 51 dBA so that the masker sound will not be noisy, the user adjusts the mixing ratio P between 30% and 50% inclusive so as to obtain a word intelligibility of 0.10. As illustrated in FIG. 3, the word intelligibility is between 0.04 to 0.10 inclusive when the masker sound pressure level is 51 dBA and the mixing ratio P is between 30% and 50% inclusive. Accordingly, with the masker sound pressure level set at 51 dBA, the user adjusts the mixing ratio P, thus obtaining a word intelligibility of 0.10 or lower, and increasing or reducing the word intelligibility to a desired value.

FIG. 4 is a graph illustrating results of a word intelligibility test conducted on nine subjects using the sound masking apparatus 1. In this test, the inventor used forest sounds as environmental sounds, and determined relationships between the word intelligibility and the masker sound pressure level, with the mixing ratio P (or disturbing sound ratio) set to 10% and 30%. FIG. 4 indicates that although the number of subjects is changed from one to nine, characteristics similar to those in FIG. 3 are obtained when the word intelligibility is 0.50 or lower. Accordingly, the user adjusts the masker sound pressure level and the mixing ratio P, thus obtaining a word intelligibility of 0.10 or lower, and increasing or reducing the word intelligibility to a desired value.

FIG. 5 is a graph illustrating results of a word intelligibility test conducted on nine subjects using the sound masking apparatus 1. In this test, the inventor used crowd sounds as environmental sounds, and determined relationships between the word intelligibility and the masker sound pressure level, with the mixing ratio P (or disturbing sound ratio) set to 10% and 30%. FIG. 5 indicates that although the type of environmental sounds is changed from forest sounds to crowd sounds, characteristics similar to those in FIG. 4 are obtained when the word intelligibility is 0.50 or lower. Accordingly, the user adjusts the masker sound pressure level and the mixing ratio P, thus obtaining a word intelligibility of 0.10 or lower, and increasing or reducing the word intelligibility to a desired value.

According to the present embodiment, the signal level Lm of the masker sound data Am always assumes a constant value irrespective of the mixing ratio P. Thus, a change in the mixing ratio P between the disturbing and environmental sounds does not change the masker sound volume. This means that once the user initially decides a desired masker sound volume, the user is allowed to change the mixing ratio between the disturbing and environmental sounds while maintaining the masker sound volume at a constant value. Consequently, the user does not have to adjust the mixing ratio between the disturbing and environmental sounds and the masker sound volume over and over again to obtain a desired masker sound.

[Variations]

Although the embodiment of the present disclosure has been described above, the present disclosure includes variations described below.

[First Variation]

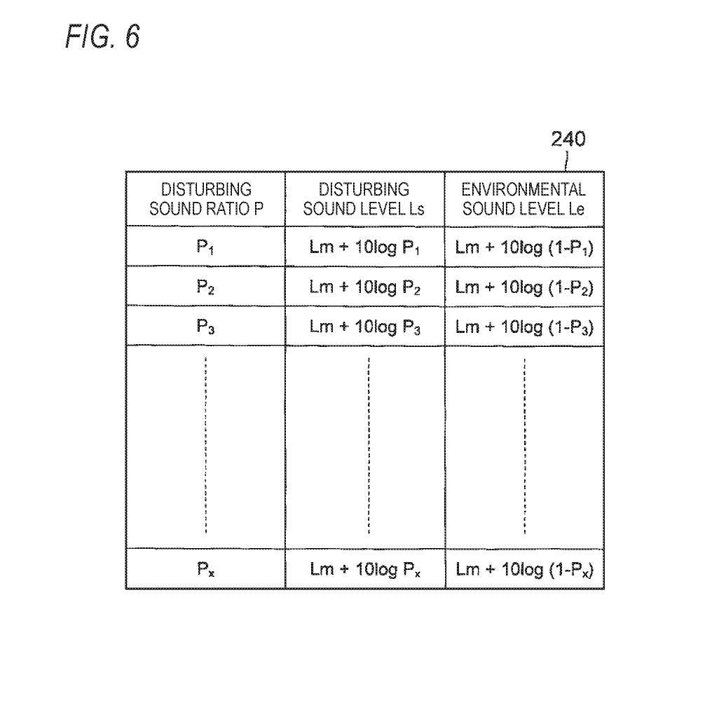

In the above embodiment, the volume controller 140 calculates the disturbing sound level Ls and the environmental sound level Le using Equations (4) and (5), respectively, on the basis of the user-set mixing ratio P between the disturbing and environmental sounds. Alternatively, the disturbing sound level Ls and the environmental sound level Le may be calculated for each of various mixing ratios P in advance, and the calculation results may be stored in a table 240. FIG. 6 illustrates an example of the table 240. The table 240 is stored in the storage 200, for example. As illustrated in FIG. 6, each disturbing sound level Ls and each environmental sound level Le are associated with the corresponding mixing ratio P in the table 240.

In this variation, upon setting of the mixing ratio P between the disturbing and environmental sounds by the user, the information acquirer 110 provides notification about this mixing ratio to each of the mixing controllers 150_1 to 150_n. Upon receiving the notification from the information acquirer 110, the mixing controllers 150_1 to 150_n each read, from the table 240, the disturbing sound level Ls and the environmental sound level Le associated with the mixing ratio P specified by the notification. The mixing controllers 150_1 to 150_n each adjust the signal levels of the disturbing sound data As and the environmental sound data Ae so that the signal level of the disturbing sound data As and the signal level of the environmental sound data Ae respectively agree with the disturbing sound level Ls and the environmental sound level Le read from the table 240. Then, the mixing controllers 150_1 to 150_n each mix the resulting disturbing sound data As and environmental sound data Ae. This variation eliminates the need for the volume controller 140, thus reducing the processing load of the CPU 100.

[Second Variation]

The sound masking apparatus 1 according to the above embodiment may be provided with a microphone, and the mixing ratio P may be automatically changed in accordance with acoustic characteristics of sounds picked up by the microphone. This eliminates the need for the user to adjust the masker sound volume Ln and the mixing ratio P, thus increasing convenience of the user.

[Third Variation]

The sound masking apparatus 1 according to the above embodiment may be provided with a disturbing sound generator. For example, the disturbing sound generator generates a plurality of types of disturbing sounds, so that an appropriate disturbing sound is emitted in accordance with conditions of an acoustic space where a person is present. Thus, more effective masking is achievable. Data of the disturbing sounds generated may be stored in a memory, for example, and made available for sale.

[Fourth Variation]

The information acquirer 110 according to the above embodiment acquires various pieces of information, including a mixing ratio, through the operating member 20. Alternatively, various pieces of information, including a mixing ratio, may be acquired from an external source, such as an external server, through a communication device, for example, without the use of the operating member 20. Thus, various instructions are provided to the sound masking apparatus 1 from, for example, a central control room, resulting in an enhancement in convenience.

[Fifth Variation]

In the above embodiment, supposing that the signal level of sound data is L (dB), for example, the volume of a sound to be emitted in accordance with this sound data is 10^{L/10}. Alternatively, a volume may be expressed in loudness, K-weighted, relative to full scale (LKFS), which is based on human auditory perception, instead of in decibels (dB).

The features of the above-described sound masking apparatus and sound masking method according to the embodiment and variations of the disclosure will be summarized below as respective items [1]-[6].

[1] The present disclosure provides a sound masking apparatus including:

an information acquirer configured to acquire a mixing ratio between a disturbing sound and a non-disturbing sound which are included in a masker sound; and

a volume controller configured to control a volume of the disturbing sound and a volume of the non-disturbing sound so as to be the mixing ratio, while a volume of the masker sound is a constant value.

[2] The sound masking apparatus recited in the item [1], further includes a level controller configured to control the volume of the masker sound at a volume level of the masker sound represented by volume information acquired by the information acquirer.

[3] In the sound masking apparatus recited in the item [1], when the mixing ratio is changed to another mixing ratio between the disturbing sound and the non-disturbing sound, the volume controller controls the volume of the disturbing sound and the volume of the non-disturbing sound so as to be the another mixing ratio, while maintaining the volume of the masker sound at the constant value.

[4] The present disclosure provides a sound masking method including:

acquiring a mixing ratio between a disturbing sound and a non-disturbing sound which are included in a masker sound; and

controlling a volume of the disturbing sound and a volume of the non-disturbing sound so as to be the mixing ratio, while a volume of the masker sound is a constant value.

[5] In the sound masking method recited in the item [4], further including: acquiring volume information; and

controlling the volume of the masker sound at a volume level of he masker sound represented by the acquired volume information.

[6] In the sound masking method recited in the item [4], further including:

acquiring another mixing ratio between the disturbing sound and the non-disturbing sound, after the process of acquiring the mixing ratio is performed,

wherein in the process of the controlling the volume of the disturbing sound and the volume of the non-disturbing sound, the volume of the disturbing sound and the volume of the non-disturbing sound are controlled so as to be the another mixing ratio, while maintaining the volume of the masker sound at the constant value.

According to the above configurations and methods, once a desired masker sound volume is set, the volume of the masker sound is maintained (unchanged) if the mixing ratio between the disturbing sound and the non-disturbing sound is changed later. Thus, once a user sets a desired masker sound volume, the user obtains a desired masker sound by simply setting a desired mixing ratio. Consequently, the user does not have to adjust the mixing ratio between the disturbing sound and the non-disturbing sound and the masker sound volume over and over again.

What is claimed is:

1. A sound masking apparatus comprising:
an information acquirer configured to acquire a mixing ratio between a disturbing sound and a non-disturbing sound which are included in a masker sound; and
a volume controller configured to control a volume of the disturbing sound and a volume of the non-disturbing sound so as to be the mixing ratio, while a volume of the masker sound is a constant value.

2. The sound masking apparatus according to claim 1, further comprising:
a level controller configured to control the volume of the masker sound at a volume level of the masker sound represented by volume information acquired by the information acquirer.

3. The sound masking apparatus according to claim 1, wherein when the mixing ratio is changed to another mixing ratio between the disturbing sound and the non-disturbing sound, the volume controller controls the volume of the disturbing sound and the volume of the non-disturbing sound so as to be the another mixing ratio, while maintaining the volume of the masker sound at the constant value.

4. A sound masking method comprising:
acquiring a mixing ratio between a disturbing sound and a non-disturbing sound which are included in a masker sound; and
controlling a volume of the disturbing sound and a volume of the non-disturbing sound so as to be the mixing ratio, while a volume of the masker sound is a constant value.

5. The sound masking method according to claim 4, further comprising:
acquiring volume information; and
controlling the volume of the masker sound at a volume level of the masker sound represented by the acquired volume information.

6. The sound masking method according to claim 4, further comprising:
acquiring another mixing ratio between the disturbing sound and the non-disturbing sound, after the process of acquiring the mixing ratio is performed; and
wherein in the process of the controlling the volume of the disturbing sound and the volume of the non-disturbing sound, the volume of the disturbing sound and the volume of the non-disturbing sound are controlled so as to be the another mixing ratio, while maintaining the volume of the masker sound at the constant value.
